(19) United States
(12) Patent Application Publication
(10) Pub. No.: US 2009/0020201 A1
(43) Pub. Date: Jan. 22, 2009

(54) Pneumatic Tire Assembly

(75) Inventor: Masaaki Ohara, Osaka (JP)

Correspondence Address: FISH & RICHARDSON P.C., P.O. BOX 1022, MINNEAPOLIS, MN, 55440-1022, US

(73) Assignee: Toyo Tire & Rubber Co., Ltd., Osaka (JP)

(21) Appl. No.: 12/170,555

(22) Filed: Jul. 10, 2008

(30) Foreign Application Priority Data
Jul. 18, 2007 (JP) 2007-187084

(51) Int. Cl. B60C 5/22

(52) U.S. Cl. 152/340.1

(57) ABSTRACT

A pneumatic tire assembly comprising a rim, a pneumatic tire that has a double structure including an outer tire and an inner tire inserted thereinto, and is assembled with the rim, and air chambers formed inside and outside the inner tire, wherein the rim includes a pair of bead seats on which bead portions of the outer tire and the inner tire are placed, a first rim flange protruding outward in a diameter direction of the tire from a side end of the bead seat, a second rim flange disposed inside the first rim flange in a rim width direction and formed on at least one of the bead seats while protruding therefrom, and an air valve provided to the second rim flange, the outer tire is held by the first rim flange and the second rim flange with the bead portion thereof being nipped therebetween, the inner tire is mounted with the bead portion thereof being in internal contact with the second rim flange, and in an outer wall surface area of the inner tire extending outward from a position of a maximum height of the second rim flange in a diameter direction of the tire, a groove portion for feeding air supplied via the air valve into the air chamber formed outside the inner tire is formed into a concave shape.

### BACKGROUND OF THE INVENTION

1. Field of the Invention

The present invention relates to a pneumatic tire assembly in which a double-structured pneumatic tire including an outer tire and an inner tire inserted thereinto is assembled with a rim.

2. Description of the Related Art

FIGS. 4 to 6 are views showing an example of a conventional pneumatic tire assembly of this type. The pneumatic tire included in the assembly has a double-structured constitution of an outer tire 6 and an inner tire 7. The outer tire 6 has a bead portion 61 which is in internal contact with a rim flange 8a. The inner tire 7 is inserted into the outer tire 6 and has a bead portion 71 which is in internal contact with the bead portion 61 of the outer tire 6. Inside the inner tire 7, an air chamber 9A is formed, and outside the inner tire 7, an air chamber 9B is formed. The air chambers 9A and 9B are filled with air and sealed air-tightly independently from each other.

In the pneumatic tire assembly as described above, even when an inner pressure of the outer tire 6 is lost due to an external damage or the like, an inner pressure of the inner tire 7 supports the pneumatic tire to prevent dramatic loss of steering stability. Therefore, as disclosed in the specifications of U.S. Pat. No. 4,995,438, U.S. Pat. No. 5,246,050, U.S. Pat. No. 5,273,093, and U.S. Pat. No. 6,688,359, such a pneumatic tire assembly is useful as a tire assembly for racing cars.

The air chamber 9A can be filled with air using an air valve 81 provided to a rim 8. On the other hand, the air chamber 9B has to be filled with air using an air valve 82 provided to a bead seat 8b through a boundary between the bead portion 71 of the inner tire 7 and the bead portion 61 of the outer tire 6. Therefore, when the bead portion 71 of the inner tire 7 is closely in internal contact with the bead portion 61 of the outer tire 6, air cannot be fed into the air chamber 9B.

To solve the above problem, in the conventional pneumatic tire assembly, a protruding portion 75 is formed at a position away from a bead heel 7h on an outer wall surface of the bead portion 71. On a surface of the protruding portion 75, air communication grooves 76 are formed into concave shapes. With this arrangement, the bead portion 61 and the bead portion 71 are kept in local contact with each other at a position away from the bead seat 8b as shown in FIG. 5. Thus, a circular space S is formed continuously between the bead heel 7h of the inner tire 7 and a bead toe 6t of the outer tire 6 in a circumferential direction of the tire. The space S and the air chamber 9B are communicated with each other via the air communication grooves 76 so that the air chamber 9B is fed with air.

In the pneumatic tire of this type, when the pneumatic tire is assembled with the rim 8, air has to be supplied through the air valve 81 to inflate only the inner tire 7 first, and then air has to be supplied through the air valve 82 to inflate the outer tire 6. The reason for this is as follows. Unless the bead portion 71 of the inner tire 7 is seated while being forced outward in a state where the inner pressure of the outer tire 6 is almost equal to zero, the bead portion 61 and 71 are hardly positioned properly. Particularly, to allow the bead portion 61 of the outer tire 6 to fit evenly with the rim flange 8a, the bead portion 61 of the outer tire 6 has to be pressed evenly and sufficiently by the bead portion 71 of the inner tire 7.

However, the conventional pneumatic tire is arranged such that the bead portion 71 of the inner tire 7 is brought into a local contact with the bead portion 61 of the outer tire 6 to form the circular space S. Therefore, a lower portion of the bead portion 61 of the outer tire 6 is hardly pressed strongly onto the rim flange 8a. Therefore, the bead portion 61 is hardly fit evenly with the rim flange 8a. As a result, the outer tire 6 tends to be mounted onto the rim 8 in an unstable posture. Moreover, when the inner tire 7 is inflated, movement of the outer tire 6 is restricted. Therefore, even when the air chamber 9B is filled with air, the outer tire 6 is hardly mounted evenly.

Further, the conventional pneumatic tire is arranged such that the bead portion 71 of the inner tire 7 is seated while being forced outward so as to press outward the bead portion 61 of the outer tire 6. When the outer tire 6 is mounted unevenly onto the rim 8, the inner tire 7 may not positioned properly due to twisting of the bead portion 71 of the inner tire 7.

As described above, in the conventional pneumatic tire assembly, the outer tire 6 tends to be mounted unevenly onto the rim 8, and further, the inner tire 7 may not be set at a desired position. As a result, there is a problem that uniformity of the tire is impaired. On the other hand, if the bead portion 71 is brought closely into internal contact with the bead portion 61, while the uniformity of the tire is improved, there arises a problem that the air chamber 9B cannot be filled with air as described above. It is difficult to satisfy both requirements to fill the air chamber 9B with air and to mount evenly the outer tire 6 and the inner tire 7.

As for the rim, as disclosed in Japanese Unexamined Utility Model Publication No. 03-2801, Japanese Examined Utility Model Publication No. 46-10401, Japanese Examined Utility Model Publication No. 46-10402, Japanese Examined Utility Model Publication No. 46-8643, Japanese Examined Utility Model Publication No. 44-28161, and Japanese Unexamined Utility Model Publication No. 55-139902, there is known one that holds the bead portion by nipping the same with a disassemble rim flange. However, to the inventor's knowledge, such a rim is not assembled with a pneumatic tire having a double structure as described above. Japanese Unexamined Utility Model Publication No. 03-2801 merely discloses a structure in which a single pneumatic tire is assembled with a rim. However, Japanese Unexamined Utility Model Publication No. 03-2801 provides no solution to the above-mentioned problems.

### SUMMARY OF THE INVENTION

Under these circumstances, the present invention has been made and an object thereof is to provide a pneumatic tire assembly allowing an air chamber formed outside an inner tire to be filled with air and allowing an outer tire and the inner tire to be evenly mounted thereby uniformity of the tire is ensured.

The above-mentioned object can be achieved by the present invention as follows. That is, the present invention provides a pneumatic tire assembly comprising: a rim; a pneumatic tire that has a double structure including an outer tire and an inner tire inserted thereinto, and is assembled with the rim, and air chambers formed inside and outside the inner tire, wherein the rim includes a pair of bead seats on which bead portions of the outer tire and the inner tire are placed, a first rim flange protruding outward in a diameter direction of the tire from a side end of the bead seat, a second rim flange disposed inside the first rim flange in a rim width direction and formed on at least one of the bead seats while protruding therefrom, and an air valve provided to the second rim flange, the outer tire is held by the first rim flange and the second rim flange with the bead portion thereof being nipped therebetween, the inner tire is mounted with the bead portion thereof being in internal contact with the second rim flange, and in an outer wall surface area of the inner tire extending outward from a position of a maximum height of the second rim flange in a diameter direction of the tire, a groove portion for feeding air supplied via the air valve into the air chamber formed outside the inner tire is formed into a concave shape.

In the pneumatic tire assembly according to the present invention, the pneumatic tire is assembled with the rim as described below. Only the inner tire is inflated first to bring the bead portion thereof into internal contact with the second rim flange. Unlike the conventional manner in which the bead portion of the inner tire presses outward the bead portion of the outer tire so as to seat the bead portion of the inner tire, the bead portion of the inner tire is mounted while being in internal contact with the second flange formed to be protruded from a predetermined position on the bead seat. With this arrangement according to the present invention, the inner tire can be mounted evenly at a desired position. Also, the first rim flange and the second rim flange hold the outer tire by nipping therebetween the bead portion thereof. With this arrangement according to the present invention, the outer tire also can be mounted evenly at a desired position.

Also, according to the present invention, the inner tire is formed with, in an outer wall surface area extending outward from a position of the maximum height position of the second rim flange in a diameter direction of the tire, groove portions in concave shapes for feeding air supplied via the air valve to the air chamber formed outside the inner tire. With this arrangement, in a state where the inner tire is inflated, even when the outer wall surface area of the inner tire is in internal contact with the inner wall surface area of the outer tire, the air chamber formed outside the inner tire can be filled with air through the groove portions. As described above, according to the present invention, the air chamber formed outside the inner tire can be appropriately filled with air as well as the outer tire and the inner tire are mounted more evenly, thereby the uniformity of the tire is ensured.

In the pneumatic tire assembly mentioned hereinbefore, it is preferable that the groove portion extends along a diameter direction of the tire, and an end portion thereof located inward in a diameter direction of the tire is disposed outward from the position of the maximum height of the second rim flange in a diameter direction of the tire.

With this arrangement, the groove portions formed on the inner tire are not brought into contact with the second rim flange. Therefore, close contact between the bead portion of the inner tire and the second rim flange is increased, as well as the inner tire can be mounted more evenly. Additionally, air supplied via the air valve can be fed efficiently into the air chamber formed outside the inner tire.

### BRIEF DESCRIPTION OF THE DRAWINGS

FIG. 1 is a sectional view showing an example of a pneumatic tire assembly according to the present invention along a meridian of the tire;

FIG. 2 is an enlarged view of an essential portion in FIG. 1;

FIG. 3 is a perspective sectional view showing an outer wall surface area of an inner tire;

FIG. 4 is a sectional view showing an example of a conventional pneumatic tire assembly along a meridian of the tire;

FIG. 5 is an enlarged view of an essential portion in FIG. 4; and

FIG. 6 is a perspective sectional view showing a bead portion of an inner tire included in the conventional pneumatic tire assembly.

### DETAILED DESCRIPTION OF THE PREFERRED EMBODIMENTS

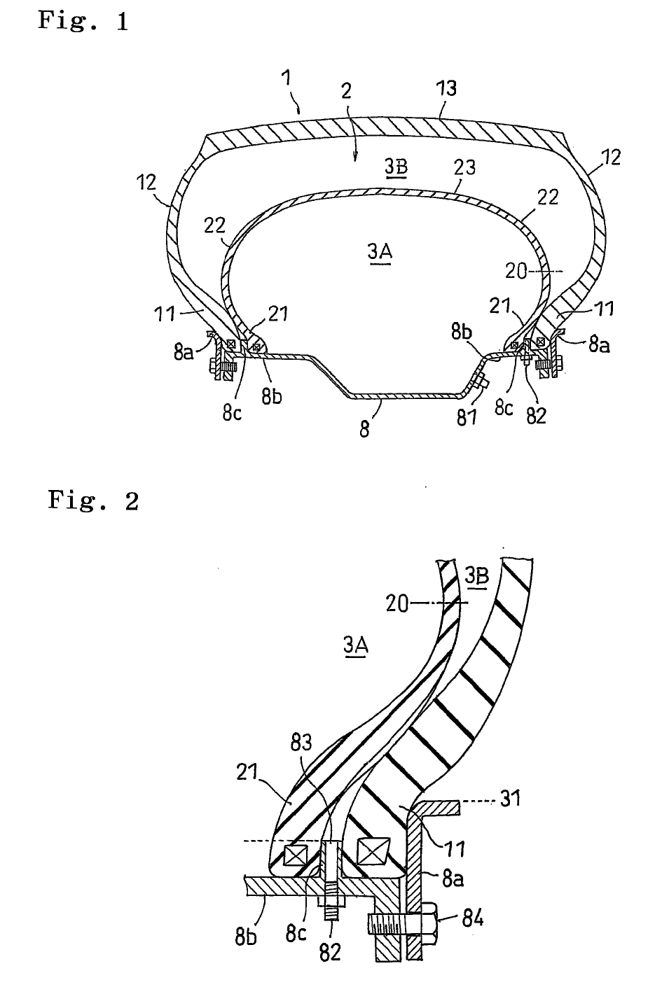

Embodiments of the present invention will now be described with reference to the accompanying drawings. FIG. 1 is a sectional view along a meridian of a tire showing an example of a pneumatic tire assembly according to the present invention. FIG. 2 is an enlarged view of an essential portion in FIG. 1.

The pneumatic tire assembly according to the present invention includes a rim 8 and a pneumatic tire that has a double structure constituted of an outer tire 1 and an inner tire 2 inserted thereinto and is assembled with the rim 8 as shown in FIG. 1 and FIG. 2. The outer tire 1 is a tubeless tire including a pair of bead portions 11, sidewall portions 12 each extending from the respective bead portions 11 outward in a diameter direction of the tire, and a tread portion 13 disposed between the sidewall portions 12. Likewise, the inner tire 2 is a tubeless tire including a pair of bead portions 21, sidewall portions 22 each extending outward in a diameter direction of the tire from the respective bead portions 21, and a tread portion 23 disposed between the sidewall portions 22.

Inside the inner tire 2, an air chamber 3A is formed between the inner tire 2 and the rim 8. Outside the inner tire 2, an air chamber 3B is formed between the inner tire 2 and the outer tire 1. Each of the air chamber 3A and the air chamber 3B is ensured to be airtight independently from each other.

The rim 8 includes a pair of bead seats 8b, first rim flanges 8a, and a second rim flange 8c. The bead portions 11 of the outer tire 1 and the bead portions 21 of the inner tire 2 are placed on the respective bead seats 8b. Each of the bead seats 8b is provided with the first rim flange 8a protruding outward from a side end thereof in a diameter direction of the tire and the second rim flange 8c formed at least one of the bead seats 8b so as to protrude therefrom, which is disposed inside the first rim flange 8a in a rim width direction.

Further, the second rim flange 8c is formed with an air hole 83, and the air hole 83 is provided with an air valve 82 therein. The present embodiment shows an example in which the first rim flange 8a in a circular shape is detachably provided to the bead seat 8b via a plurality of bolts 84. The second rim flange 8c may be formed to the respective bead seats 8b on both sides so as to protrude therefrom. However, the present invention is not limited thereto. At least the one second rim flange 8c has to be formed to the bead seat 8b provided with the air valve 82.

The air chamber 3A can be filled with air via an air valve 81 provided to the rim 8. On the other hand, the air chamber 3B can be filled with air via the air valve 82 provided to the second rim flange 8c, as will be described later in detail. In a state where both of the air chambers 3A and 3B are filled with air, the outer tire 1 is held by the first rim flange 8a and the second rim flange 8c with the bead portion 11 while being nipped therebetween; and the inner tire 2 is mounted with the bead portion 21 while being in internal contact therewith. With this arrangement, the outer tire 1 and the inner tire 2 can be mounted evenly at a desired position respectively.

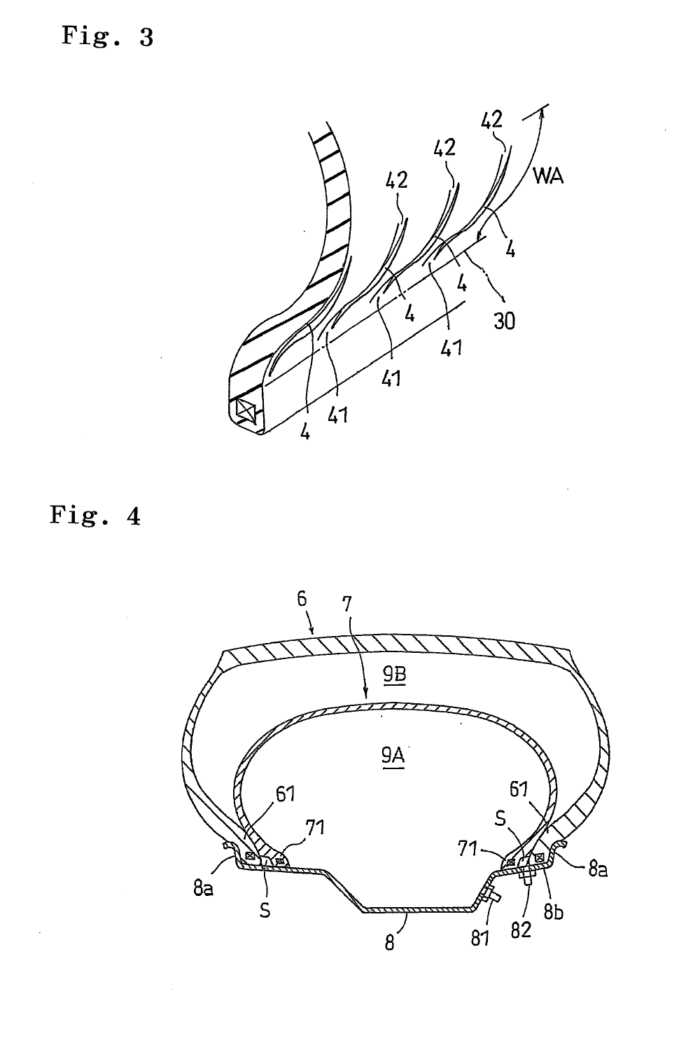

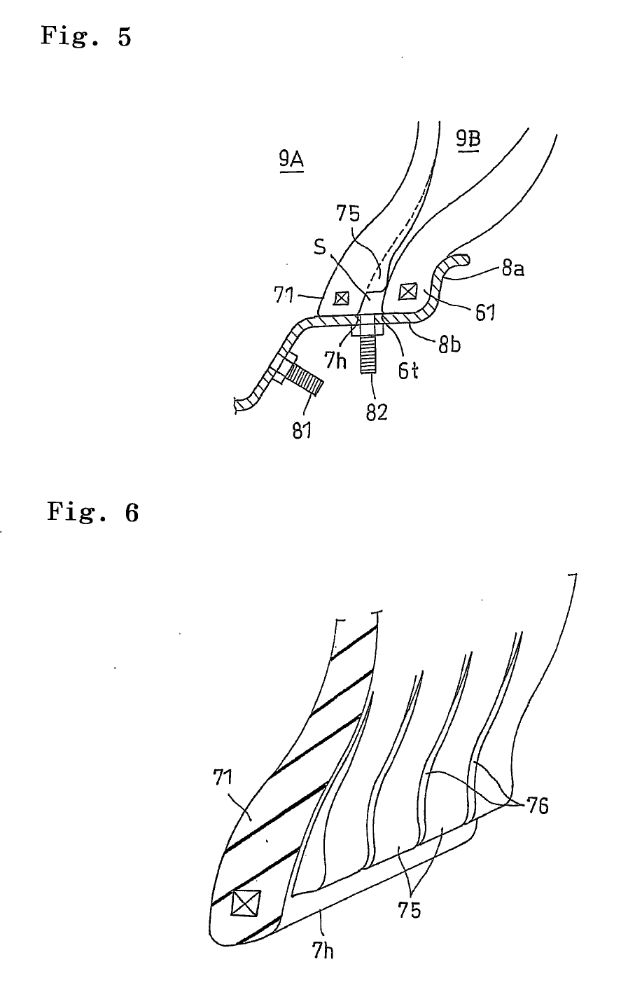

In an outer wall surface area WA of the inner tire 2, which extends outward in a diameter direction of the tire from a maximum height position 30 of the second rim flange 8c, groove portions 4 for feeding air supplied from the air valve 82 into the air chamber 3B formed outside the inner tire 2 is formed in concave shapes, as shown in FIG. 3. With this arrangement, even when the inner tire 2 is inflated and the outer wall surface areas WA of the inner tire 2 are brought into internal contact with the inner wall surface area of the outer tire 1, the air chamber 3B formed outside the inner tire 2 can be filled with air via the groove portions 4.

The groove portions 4 may be formed in the outer wall surface areas WA on the both sides of the bead portions 21 of the inner tire 2. However, the present invention is not limited thereto. The groove portions 4 have to be formed in the outer wall surface area WA in the bead portion 21 at least on the side where the air valve 82 is provided to the bead seat 8b.

The width and depth of the groove portions 4 is not particularly limited. However, for example, the width of the groove may be 5 mm or more, and the depth thereof may be the same as the width or less. Further, it is preferred that the groove portions 4 extend along a diameter direction of the tire, thereby air supplied via the air valve 82 can be fed efficiently into the air chamber 3B. As described above, when the groove portion 4 includes no element continuously extending circularly in a circumferential direction of the tire, the rigidly of the bead portion 21 of the inner tire 2 is prevented from being changed, and thus, the durability of the inner tire 2 is ensured. It is preferred that a plurality of the groove portions 4 is formed, thereby air supplied via the air valve 82 is fed effectively into the air chamber 3B.

End portions 41 of the groove portions 4 located inward in a diameter direction of the tire are disposed outside the maximum height position 30 of the second rim flange 8c in a diameter direction of the tire. With this arrangement, the close contact between the bead portion 21 of the inner tire 2 and the second rim flange 8c is increased, and further, the inner tire 2 can be mounted more evenly. Also, the end portions 42 of the groove portions 4 located outward in a diameter direction of the tire are disposed outside the maximum height position 31 of the first rim flange 8a in a diameter direction of the tire. The groove portions 4 may extend up to, for example, the maximum width position 20 of the inner tire 2.

The outer tire 1 and the inner tire 2 are assembled with the rim 8 in the following manner. The inner tire 2 is assembled with the rim 8 first, and then each of the bead portions 11 of the outer tire 1 is held while being nipped between the first rim flange 8a and the second rim flange 8c respectively. Subsequently, only the inner tire 2 is inflated by filling the air chamber 3A with air via the air valve 81, and then each of the bead portions 21 is mounted while being in internal contact with the second rim flange 8c.

After the inner tire 2 is inflated by filling the air chamber 3A with air, also in a state where the outer wall surface area WA of the inner tire 2 is in internal contact with the inner wall surface area of the outer tire 1, the outer tire 1 can be inflated by feeding air supplied via the air valve 82 to the air chamber 3B through the groove portions 4. As a result, the air chamber 3B can be appropriately filled with air; and thus the outer tire 1 and the inner tire 2 can be mounted evenly.

The pneumatic tire assembly according to the present invention may be configured in the same manner as the conventional manner excepting the following points. The pneumatic tire is assembled onto the rim 8 with each of the bead portions 11 of the outer tire 1 held by the first rim flange 8a and the second rim flange 8c while being nipped therebetween, and the inner tire 2 is formed with the groove portions 4 as described above, and the bead portions 21 thereof are brought into internal contact with the second rim flange 8c. Therefore, conventionally known materials, configurations, structures and the like may be employed to the outer tire 1 and the inner tire 2.

In the above described embodiment, there is shown an example in which the groove portions 4 extend along a diameter direction of the tire. However, the invention is not limited thereto. The groove portions may extend at an angle with respect to the diameter direction of the tire. Further, as long as air supplied via the air valve provided to the second rim flange can be fed to the air chamber formed outside the inner tire, the configuration of the groove portions is not particularly limited.

Furthermore, the above described embodiment shows an example in which the circular first rim flange 8a is detachably assembled via the plurality of bolts 84. However, the present invention is not limited thereto. For example, the bead seat, which is disposed outside the second rim flange in a rim width direction, may be arranged detachably and integrally with the first rim flange, or the first rim flange may be fixedly attached to the side end of the bead seat.

What is claimed is:

1. A pneumatic tire assembly comprising:
a rim;
a pneumatic tire that has a double structure including an outer tire and an inner tire inserted thereinto, and is assembled with the rim, and
air chambers formed inside and outside the inner tire, wherein
the rim includes a pair of bead seats on which bead portions of the outer tire and the inner tire are placed, a first rim flange protruding outward in a diameter direction of the tire from a side end of the bead seat, a second rim flange disposed inside the first rim flange in a rim width direction and formed on at least one of the bead seats while protruding therefrom, and an air valve provided to the second rim flange,
the outer tire is held by the first rim flange and the second rim flange with the bead portion thereof being nipped therebetween,
the inner tire is mounted with the bead portion thereof being in internal contact with the second rim flange, and in an outer wall surface area of the inner tire extending outward from a position of a maximum height of the second rim flange in a diameter direction of the tire, a groove portion for feeding air supplied via the air valve into the air chamber formed outside the inner tire is formed into a concave shape.

2. The pneumatic tire assembly according to claim 1, wherein the groove portion extends along a diameter direction of the tire, and an end portion thereof located inward in a diameter direction of the tire is disposed outward from the position of the maximum height of the second rim flange in a diameter direction of the tire.
